(19) United States
(12) Patent Application Publication
(10) Pub. No.: US 2013/0032718 A1
(43) Pub. Date: Feb. 7, 2013

(54) RF IMMUNITY IMPROVED PYRO SENSOR

(71) Applicant: William DiPoala, Fairport, NY (US)

(72) Inventor: William DiPoala, Fairport, NY (US)

(73) Assignees: Robert Bosch GmbH, Stuttgart (DE); Bosch Security System Inc., Fairport, NY (US)

(21) Appl. No.: 13/267,845

(22) Filed: Oct. 6, 2011

Related U.S. Application Data
(60) Provisional application No. 61/514,616, filed on Aug. 3, 2011.

(51) Int. Cl. G01J 5/34

(52) U.S. Cl. 250/338.3

(57) ABSTRACT

A pyro sensor is for use in a passive infrared motion detector. The pyro sensor includes at least one passive infrared sensor element. A field effect transistor includes a drain, a gate and a source. The gate is connected to the at least one passive infrared sensor element. A first capacitor interconnects the source and ground. The first capacitor has a value of approximately between 47 picoFarads and 1000 picoFarads. A second capacitor interconnects the source and ground. The second capacitor has a value of approximately between 4.7 picoFarads and 47 picoFarads.

### RELATED APPLICATION

This application is a nonprovisional of, and claims the benefit of, provisional application 61/514,616, filed Aug. 3, 2011, entitled “RF IMMUNITY IMPROVED PYRO SENSOR”, by applicant William DiPoala, which is hereby incorporated by reference herein in its entirety.

### BACKGROUND

1. Field of the Invention

The patent relates to the field of motion detection and more particularly to pyro sensors used in passive infrared (PIR) motion detectors.

2. Description of the Related Art

In the field of surveillance and security systems, the pyro sensor used in passive infrared (PIR) motion detectors is a critical component that determines the overall performance of the detector. False alarms can be caused by radio frequency interference (RFI) in the PIR motion detector if proper measures are not taken when designing the system.

As an increasing number of radio frequency (RF) devices proliferate the global environment, higher frequency channels are being opened up and used in order to prevent crosstalk or jamming by other devices operating on the same frequency. These higher frequency channels are moving into the microwave spectrum (greater than 1 GHz).

The standardized RFI/EMI tests such as the EN6100-4-3 are moving to test the RF immunity of devices at frequencies as high as 6 GHz at 10 V/m. The EN50130-4 standard further defines the requirements for a PIR detector to be immune to frequencies as high as 2.7 GHz. The PIR motion detectors sold today need to pass these test requirements in order to be effective in the marketplace.

FIG. 1 shows a schematic diagram of a typical conventional pyro sensor 20 disposed within a metal can or housing 22. Sensor 20 includes an optical filter 24, and sensor elements 26a-b detecting optical energy through filter 24. A field effect transistor (FET) 28 includes a gate 30, a drain 32 and a source 34. A gate resistor 36 interconnects gate 30 and electrical ground. An EMI resistor 38 may be connected to drain 32. A 100 pF capacitor 40 is connected to source 34 in order to reduce noise caused by RF radiation.

Pyro sensor 20 and other pyro sensors used today are not capable of providing sufficient electro-magnetic immunity at the higher frequencies as needed. Thus, what is neither disclosed nor suggested by the prior art is a surveillance security system including a PIR motion detector which provides the needed level of RFI immunity.

### SUMMARY

The invention is directed to a security system including a pyro sensor having improved immunity to electromagnetic interference (EMI).

In one aspect, the invention includes a pyro sensor for use in a passive infrared motion detector. The pyro sensor includes at least one passive infrared sensor element. A field effect transistor includes a drain, a gate and a source. The gate is connected to the at least one passive infrared sensor element. A first capacitor interconnects the source and ground. The first capacitor has a value of approximately between 75 picoFarads and 470 picoFarads. A second capacitor interconnects the source and ground. The second capacitor has a value of approximately between 10 picoFarads and 25 picoFarads.

In another aspect, the invention includes a pyro sensor for use in a passive infrared motion detector. The pyro sensor includes at least one passive infrared sensor element. A field effect transistor includes a drain, a gate and a source. The gate is connected to the sensor element. A first capacitor interconnects the source and ground. The first capacitor has a value of approximately between 82 picoFarads and 330 picoFarads. A second capacitor interconnects the source and ground. The second capacitor has a value of approximately between 10 picoFarads and 20 picoFarads. An electrically conductive trace interconnects the second capacitor and the source. The trace has an impedance of less than 40 Ohms.

In yet another aspect, the invention includes a pyro sensor for use in a passive infrared motion detector. The pyro sensor includes at least one passive infrared sensor element. A field effect transistor includes a drain, a gate and a source. The gate is connected to the sensor element. A first capacitor interconnects the source and ground. The first capacitor has a value of approximately between 82 picoFarads and 220 picoFarads. A second capacitor interconnects the source and ground. The second capacitor has a value of approximately between 10 picoFarads and 20 picoFarads. An impedance of the first capacitor is at least five times greater than an impedance of the second capacitor at a frequency of 2 GHz.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of an example pyro sensor;

FIG. 2 is a block diagram of one embodiment of an example pyro sensor of the present invention;

FIG. 3 is a pair of plots of impedance as a function of frequency for the two source capacitors of the pyro sensor of FIG. 2; and

FIG. 4 illustrates a microscopic plan view of the pyro sensor 120 of FIG. 2.

Corresponding reference characters indicate corresponding parts throughout the several views. Although the drawings represent embodiments of the invention, the drawings are not necessarily to scale and certain features may be exaggerated in order to better illustrate and explain the invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

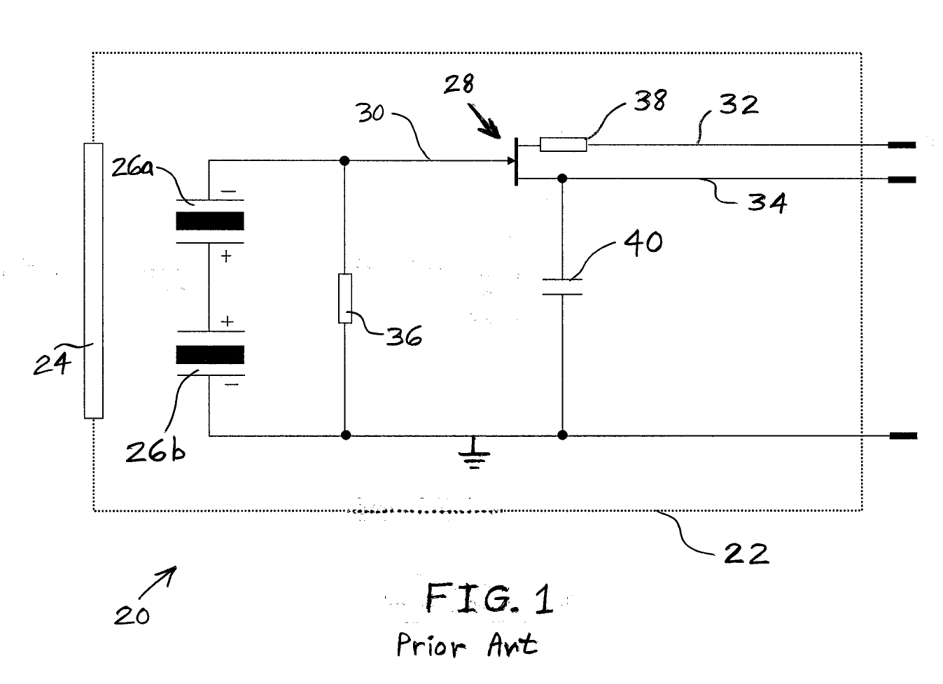

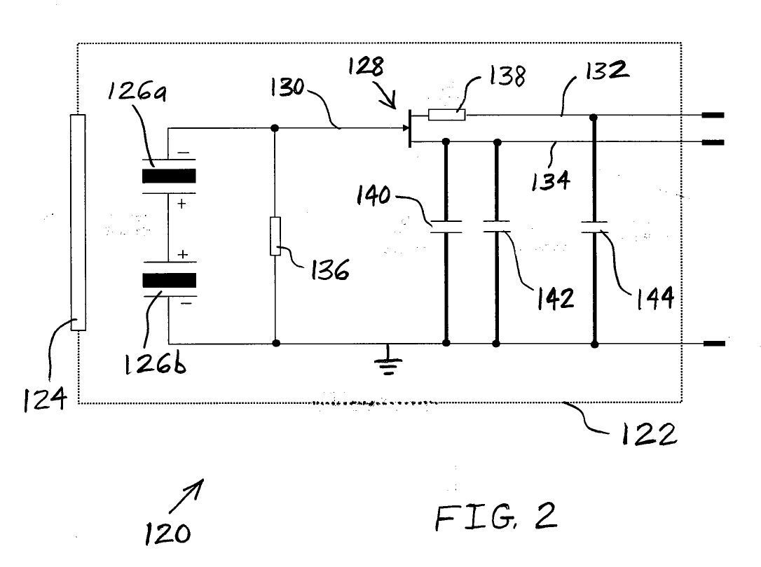

Referring to FIG. 2, there is shown one embodiment of a pyro sensor 120 of the invention. Pyro sensor 120 may be disposed within a metal can or housing 122. Sensor 120 includes an optical filter 124, and sensor elements 126a-b detecting optical energy through filter 124. A field effect transistor (FET) 128 includes a gate 130, a drain 132 and a source 134. A gate resistor 136 interconnects gate 130 and electrical ground. An EMI resistor 138 may be connected to drain 132. As in the example of FIG. 1, a 100 pF capacitor 140 may be connected to source 134. However, in order to further reduce noise caused by RF radiation (e.g., reduce electro-magnetic interference), a 15 pF capacitor 142 is connected to source pin 134 in parallel with capacitor 140.

In one embodiment, both capacitors 140, 142 are in 0402 surface mount two-terminal packages. In one embodiment, 100 pF capacitor 140 is in the form of a monolithic ceramic capacitor no. GRM1555C1H101JZ01, and 15 pF capacitor 142 is in the form of a monolithic ceramic capacitor no. GRM1555C1H150JZ01, both marketed by Murata Manufacturing Co., Ltd.

The 15 pF capacitor 142 may provide a lower impedance than 100 pF capacitor 140 at frequencies above 1 GHz. The lower impedance capacitor 142 provides a better path to direct the RF energy to ground, bypassing the sensitive pyro circuitry (not shown) which may be connected to drain 132 and source 134.

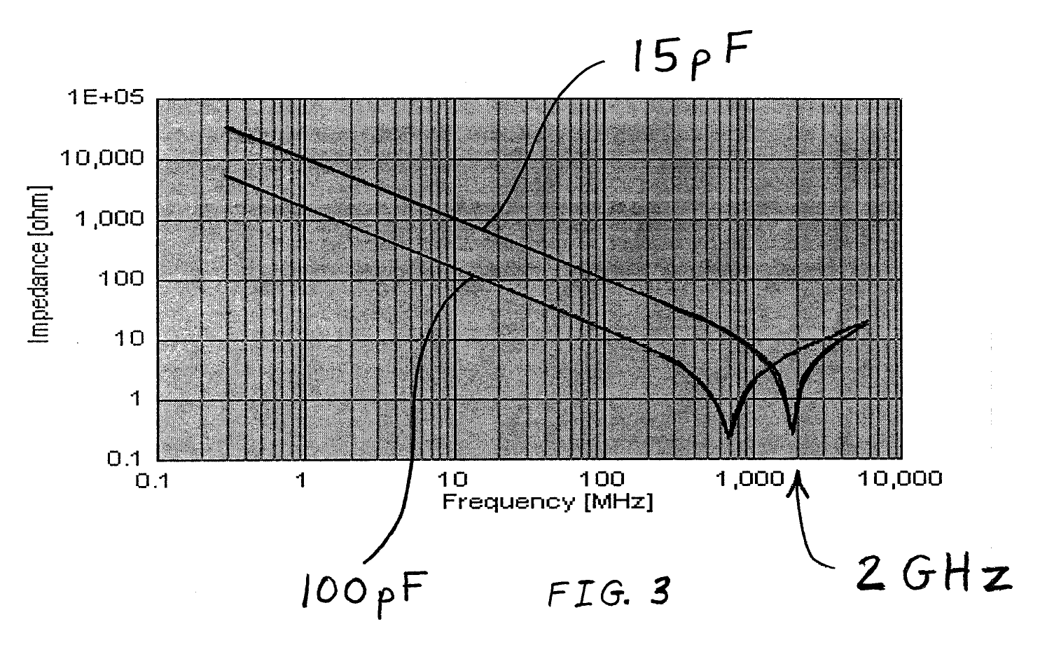

The impedances of the 100 pF capacitor 140 and the 15 pF capacitor 142 are plotted in FIG. 3. The 15 pF capacitor 142 may provide a bypass impedance of less than five Ohms between 1.5 GHz and 2.5 GHz. The impedance of the 100 pF capacitor 140 connected to source 134 may be over five times larger than the impedance of the 15 pF capacitor 142 between 1.5 GHz and 2.5 GHz. More particularly, as shown in the plot of FIG. 3, the impedance of the 100 pF capacitor 140 may be about ten times larger than the impedance of the 15 pF capacitor 142 at 2.0 GHz. As also shown in the plot of FIG. 3, the impedance of the two source capacitors 140, 142 may be non-linear and/or may have non-ideal characteristics at operating frequencies that are this high (e.g., above about 500 MHz). Because of the non-linearity and/or non-ideal characteristics of the capacitors 140, 142 at these high frequencies, it has been found that the advantages of the invention are better achieved by arranging the two capacitors in parallel rather than providing a single 115 pF capacitor. A 115 pF capacitor may be equivalent to the 100 pF and 15 pF parallel capacitor combination only in the linear frequency region wherein the characteristics of the capacitors are more linear and/or ideal.

It may be beneficial for the 15 pF capacitor 142 to have a low impedance connection to source pin 134 of FET 128 and to ground. This low impedance connection may be achieved by making the connecting copper PCB traces short and wide on both sides of capacitor 142. It may also be beneficial to provide the ground connection to the can 122 directly below the negative terminal of capacitor 142.

The width of the traces used in most known pyro sensors is about 0.01 inch. The impedance of a known 0.01 inch wide trace may be calculated to be about 60 Ohms. In one embodiment, the impedance of the trace of the invention is less than 50 Ohms at a frequency of 1.5 GHz. Because the impedance of the trace is largely resistive, the resistance of the trace is also less than 50 Ohms. The calculated impedance of a 0.05 inch wide and 0.01 inch thick trace of the invention may be about 24 Ohms at a frequency of 1.5 GHz. The resistance of the 0.05 inch wide trace of the invention may also be about 24 Ohms.

An electro-magnetic interference capacitor 144 may be connected to drain pin 132 as a bypass capacitor. The value of this drain capacitor 144 can be in the range of 10 pF to 470 pF. In a particular embodiment, the value of the drain capacitor is 100 pF.

Any or all of capacitors 140, 142, 144 may have low impedance traces and/or low impedance connections on one or both of its two terminals. For example, any or all of these six traces may have a width of about 0.05 inch and a length of less than 0.05 inch. In some embodiments, any or all of these six traces may have a length of about 0.03 inch and a thickness of about 0.01 inch.

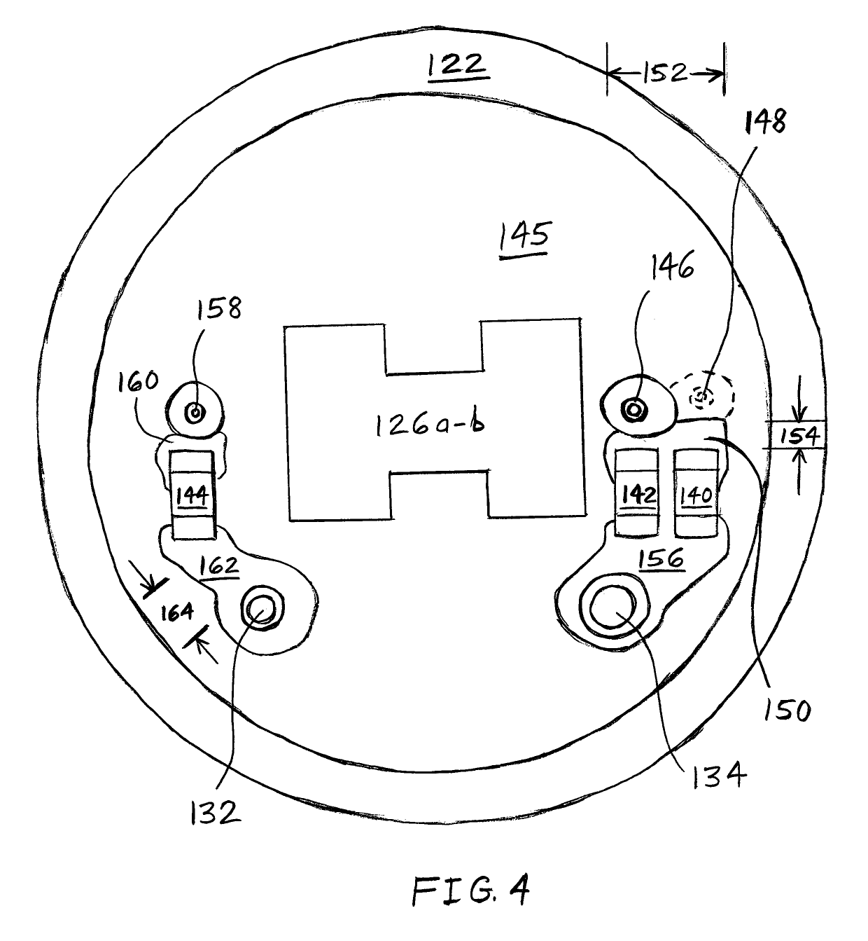

FIG. 4 illustrates a microscopic image of pyro sensor 120 of the invention. The circuit board 145 on which sensor 120 is mounted may include a ground via 146 that is disposed close to capacitors 140, 142. An optional second ground via 148 may also be disposed close to capacitors 140, 142. For example, capacitor 142 may be disposed about 0.03 inch from ground via 146, and capacitor 140 may be disposed about 0.03 inch from ground via 148. Ground vias 146, 148 may be electrically connected to can 122 on the side of circuit board 145 opposite that shown in FIG. 4. Ground via 146 may have conductive epoxy applied thereto on the side of circuit board 145 opposite that shown in FIG. 4.

Capacitors 140, 142 share a common low impedance connection 150 to ground vias 146, 148. In one embodiment, a width 152 of connection 150 is about 0.05 inch, and a length 154 of connection 140 is about 0.03 inch. Thus, a ratio of width to length of connection 150 is about 5 to 3, or about 1.67. Similarly, capacitors 140, 142 share a common low impedance connection 156 to source via 134a. In one embodiment, a width of connection 156 is about 0.05 inch, and a length of connection 156 between capacitor 142 and source via 134a is about 0.03 inch. Thus, a ratio of width to length of connection 156 is about 5 to 3, or about 1.67.

Circuit board 145 may include a ground via 158 that is disposed close to drain capacitor 144. For example, capacitor 144 may be disposed about 0.02 inch from ground via 158. Ground via 158 may be electrically connected to can 122 on the side of circuit board 145 opposite that shown in FIG. 4. Capacitor 144 has a low impedance connection 160 to ground via 158. In one embodiment, a width of connection 160 is about 0.03 inch, and a length of connection 160 is about 0.02 inch. Thus, a ratio of width to length of connection 160 is about 3 to 2, or about 1.5. Similarly, capacitor 144 has a low impedance connection 162 to drain via 132a. In one embodiment, a width of connection 162 is about 0.05 inch, and a length 164 of connection 162 between capacitor 144 and drain via 132a is about 0.05 inch. Thus, a ratio of width to length of connection 162 is about 1.0.

Although the drain resistor, gate resistor and FET are not shown in FIG. 4 in order to simplify the illustration, it is to be understood that any or all of these components may be visible from the viewpoint depicted by FIG. 4. Further, any or all of these components may be mounted on the same circuit board 145 that other components of FIG. 4 are mounted on.

Although the capacitors of the present invention have been described herein as ceramic, it is to be understood that other types of capacitive elements may be used within the scope of the invention. For example, any or all of capacitors 140, 142, 144 may be Mylar capacitors, polystyrene capacitors, and/or polypropylene film capacitors, for example.

While this invention has been described as having an exemplary design, the invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A pyro sensor for use in a passive infrared motion detector, the pyro sensor comprising:
at least one passive infrared sensor element;
a field effect transistor including a drain, a gate and a source, the gate connected to the sensor element;
a first capacitor interconnecting the source and ground, the first capacitor having a value of approximately between 47 picoFarads and 1000 picoFarads; and
a second capacitor interconnecting the source and ground, the second capacitor having a value of approximately between 4.7 picoFarads and 47 picoFarads.

2. The sensor of claim 1, wherein the drain includes a resistor.

3. The sensor of claim 1, wherein the second capacitor has an impedance of less than approximately 5 Ohms at a frequency of approximately between 1.5 GHz and 2.5 GHz.

4. The sensor of claim 1, further comprising an electrically conductive trace interconnecting the second capacitor and the source, the trace having an impedance of less than 50 Ohms at a frequency of 1.5 GHz.

5. The sensor of claim 1, further comprising an electrically conductive trace interconnecting the second capacitor and the source, the trace having a width of greater than 0.03 inch.

6. The sensor of claim 1, further comprising an electrically conductive trace interconnecting the second capacitor and ground, the trace having an impedance of less than 50 ohms.

7. The sensor of claim 1, further comprising an electrically conductive trace interconnecting the second capacitor and ground, the trace having a width of greater than 0.03 inch.

8. The sensor of claim 1, further comprising a grounded metal can housing, the second capacitor being connected to the grounded metal can housing with a trace less than 0.1 inch long.

9. The sensor of claim 1, wherein an impedance of the first capacitor is at least five times greater than an impedance of the second capacitor at a frequency of 2 GHz.

10. The sensor of claim 1, further comprising a third capacitor interconnecting the drain and ground, the third capacitor having a value of approximately between 4.7 picoFarads and 1000 picoFarads.

11. The sensor of claim 10, wherein the drain includes a resistor interconnecting the gate and the third capacitor.

12. The sensor of claim 1, further comprising a gate resistor connected in a parallel combination with the at least one sensor, the parallel combination having a first grounded terminal and a second terminal, the gate being connected to the second terminal of the parallel combination.

13. A pyro sensor for use in a passive infrared motion detector, the pyro sensor comprising:
at least one passive infrared sensor element;
a field effect transistor including a drain, a gate and a source, the gate connected to the sensor element;
a first capacitor interconnecting the source and ground, the first capacitor having a value of approximately between 47 picoFarads and 1000 picoFarads;
a second capacitor interconnecting the source and ground, the second capacitor having a value of approximately between 4.7 picoFarads and 47 picoFarads; and
an electrically conductive trace interconnecting the second capacitor and the source, the trace having a resistance of less than 40 Ohms.

14. The sensor of claim 13, wherein the second capacitor has an impedance of less than approximately 5 Ohms at a frequency of approximately between 1.5 GHz and 2.5 GHz.

15. The sensor of claim 13, wherein an impedance of the first capacitor is at least five times greater than an impedance of the second capacitor at a frequency of 2 GHz.

16. The sensor of claim 13, further comprising a third capacitor interconnecting the drain and ground, the third capacitor having a value of approximately between 4.7 picoFarads and 1000 picoFarads.

17. A pyro sensor for use in a passive infrared motion detector, the pyro sensor comprising:
at least one passive infrared sensor element;
a field effect transistor including a drain, a gate and a source, the gate connected to the sensor element;
a first capacitor interconnecting the source and ground, the first capacitor having a value of approximately between 47 picoFarads and 1000 picoFarads; and
a second capacitor interconnecting the source and ground, the second capacitor having a value of approximately between 4.7 picoFarads and 47 picoFarads;
wherein an impedance of the first capacitor is at least five times greater than an impedance of the second capacitor at a frequency of 2 GHz.

18. The sensor of claim 17, wherein the second capacitor has an impedance of less than approximately 5 Ohms at a frequency of approximately between 1.5 GHz and 2.5 GHz.

19. The sensor of claim 17, further comprising an electrically conductive trace interconnecting the second capacitor and the source, the trace having an impedance of less than 30 Ohms at 2 GHz.

20. The sensor of claim 17, further comprising a third capacitor interconnecting the drain and ground, the third capacitor having a value of approximately between 4.7 picoFarads and 1000 picoFarads.
